(19) United States
(12) Patent Application Publication
(10) Pub. No.: US 2024/0083071 A1
(43) Pub. Date: Mar. 14, 2024

(54) Recyclable Plastic Products and Methods of Making and Using Same

(71) Applicant: Joseph Ross, Manhattan Beach, CA (US)

(72) Inventor: Joseph Ross, Manhattan Beach, CA (US)

(21) Appl. No.: 18/242,959

(22) Filed: Sep. 6, 2023

Related U.S. Application Data
(60) Provisional application No. 63/405,261, filed on Sep. 9, 2022.

(51) Int. Cl. B29B 17/00; B29C 71/00

(52) U.S. Cl. CPC B29B 17/0036; B29C 71/0063; B29B 13/02

(57) ABSTRACT

Methods are provided for making and recycling recyclable food grade plastic products from recycled, post-consumer plastic. The recyclable food grade plastic products may have wash away labels with printed text, graphics, or images that can be easily removed such that the plastic product may be recycled into FDA-approved food grade (i.e., food safe) plastic that is capable of being reused to manufacture new recyclable food grade products.

### CROSS-REFERENCE TO RELATED APPLICATIONS

The present application claims the benefit of U.S. Provisional Patent Application No. 63/405,261, filed on Sep. 9, 2022, the entire disclosure of which is hereby incorporated herein by reference.

### FIELD OF THE INVENTION

The current invention generally relates to recyclable plastic products, including recyclable food grade plastic products, such as cups and containers, manufactured with virgin plastic, post-consumer recycled plastic, bioplastic, and/or combinations thereof, and wash away labels and to methods of making, using, and recycling same.

### BACKGROUND OF THE INVENTION

Single-use plastics are goods that are made primarily from fossil fuel-based chemicals (petrochemicals) and are meant to be disposed of right after use—often, in mere minutes. Single-use plastics are most commonly used for packaging, and food and beverage serviceware, such as bottles, wrappers, straws, bags, cups, and containers.

As a result of society's reliance on these single-use plastics, post-consumer plastic waste is accumulating at a staggering rate. There are trillions of recyclable food grade plastic products, including for example, food and beverage containers and cups, which are used and disposed of annually around the world. Millions of pounds of post-consumer plastic waste end up in landfills every year. We produce 300 million tons of plastic each year worldwide, half of which is for single-use items. In the U.S. alone, 54 billion pounds of plastic are landfilled each year. Plastic also ends up in our environment—i.e., rivers, oceans, and beaches—with devastating effects to wildlife and the climate.

Recycling more plastic, more frequently, advantageously reduces its footprint. Polyethylene terephthalate (PET), one of the most commonly recycled plastics and the material that is used to manufacture most food and beverage containers and cups, can be turned into everything from polyester fabric to automotive parts. But, currently, more than 90% percent of all plastic isn't recycled at all. Single-use plastics in particular—especially small items like straws, bags, and cutlery—are traditionally hard to recycle because they fall into the crevices of recycling machinery and therefore are often not accepted by recycling centers.

Additionally, while there are existing methods for recycling bottle-grade, injection molded and blow molded PET plastic products (e.g., PET bottles and jars), there are no existing processes for recycling thermoform plastic products, such as food and beverage containers, which are commonly formed of PET and other plastics having a lower intrinsic viscosity (IV) measurement than bottle-grade products. Thermoform containers pose a number of recycling challenges that are distinct from non-thermoform plastic products (such as plastic bottles).

First, the inconsistency in plastic resins utilized for manufacturing thermoformed products is one major obstacle for recycling. While PET is the favored resin in the recycling industry, a significant proportion of thermoforms are made from oriented polystyrene (OPS), high density polyethylene (HDPE), and polypropylene (PP). Additionally, thermoform manufacturers often employ PET alternatives like PLA, and PETG, and bioplastic, further complicating the recycling process.

Labeling, and the use of adhesives to secure labels to the plastic, pose additional obstacles to recycling thermoforms. There is generally a lack of uniformity of labels used on thermoformed plastic containers, which can create technical complications in the process. Additionally, due to the intended use of most thermoform containers (for example being exposed to produce misters, refrigeration, condensation, and close physical contact with other containers, the label adhesives used on thermoformed products is generally much more aggressive than the glue used on plastic bottles. This characteristic makes the removal of labels from PET and other plastic surfaces and flakes more challenging. Furthermore, the residues from these adhesives can contaminate washing solutions, hampering the recycling process.

Additionally, Intrinsic Viscosity (IV), a measure of plastic's tensile strength and elasticity, differs notably between PET thermoforms and non-thermoformed containers such as bottles. This variance makes it difficult to process bottles and thermoforms together.

Finally, the thinness of thermoform containers causes a “bulk density” concern in the reclamation process. Recycled plastics are generally ground into flake form prior to washing, and if the flakes are too light, they can have problems flowing through the wash and decontamination processes. These challenges generally prevent thermoformed plastic products from being recycled, much less being reclaimed into FDA-approved food grade (i.e., food safe) plastic that can be manufactured back in to new recyclable food grade plastic products.

Moreover, there are currently no recycling processes specifically designed to recycle recyclable food grade plastic products that have text, graphics, or images printed thereon. Existing ink systems used to print text, graphics, or images on plastic items generally render the plastic unsuitable for being recycled under any circumstances.

In particular, conventional “direct print” ink systems which are generally used to print text, graphics, or images directly on plastic products cannot be easily removed to permit recycling of the plastic items themselves. Attempts to recycle such printed plastic products, in general, result in the printing ink contaminating the post-consumer plastic recycle stream. Likewise, a common challenge with conventional printed labels when recycling plastic products is that the label material, adhesive, and ink can contaminate the recycled plastic. Such contamination prevents these items from being recycled into FDA-approved food grade (i.e., food safe) plastic that can be manufactured back in to new recyclable food grade plastic products.

Thus, a need exists for recyclable thermoformed food grade plastic products, such as food and beverage containers and cups. Likewise, a need exists for recyclable food grade plastic products with printed text, graphics, or images that can be easily removed such that the plastic product may be recycled into FDA-approved food grade plastic that is capable of being reused in new food grade products. Likewise, a need exists for methods of making and recycling recyclable thermoformed food grade plastic products with printed text, graphics, or images that can be easily removed such that the plastic product may be recycled into FDA approved food grade plastic that is capable of being reused in new recyclable food grade products.

Additionally, there is a need for recyclable food grade plastic products manufactured, at least in part, from recycled post-consumer plastic and/or bioplastic. This “circular” sustainability effort will advantageously allow millions of pounds of post-consumer plastic waste to be diverted from landfills and the environment every year and reused.

### SUMMARY OF THE INVENTION

The current invention addresses the above-noted and other shortcomings by the various inventive aspects described herein. The current invention is described in the Detailed Description of the Preferred Embodiments, including the figures, as well as in the claims, appearing later. The following Summary of the Invention describes aspects of the current invention.

In an aspect of the invention, methods are provided for manufacturing recyclable thermoformed food grade (i.e., food safe) plastic products. In one form, the recyclable food grade plastic products are manufactured from at least a portion of recycled, post-consumer plastic. In one form, the recyclable plastic products are preferably manufactured using at least 1% post-consumer recycled plastic, more preferably, at least 10% post-consumer recycled plastic, and even more preferably, at least 50% post-consumer recycled plastic. In any event, the current invention includes varying percentage usage of post-consumer recycled plastic (from 0% to 100%).

In another form, methods are provided for manufacturing recyclable food grade plastic products from at least a portion of bioplastic resin. In one form, the recyclable food grade plastic product may be manufactured from at least 1% bioplastic, more preferably, at least 10% bioplastic, and even more preferably, at least 50% bioplastic. In any event, the current invention includes varying percentage usage of bioplastic (from 0% to 100%).

In another aspect of the invention, methods are provided for manufacturing recyclable food grade plastic products which have printed text, graphics, or images thereon that can be easily removed such that the plastic product may be recycled into FDA-approved food grade plastic that is capable of being reused to manufacture new recyclable food grade products.

In another aspect of the invention, recyclable food grade plastic products are provided that are manufactured, at least in part, from recycled, post-consumer plastic. In one form, the recyclable plastic products contain least 1% post-consumer recycled plastic, more preferably, at least 10% post-consumer recycled plastic, and even more preferably, at least 50% post-consumer recycled plastic. In any event, the current invention includes varying percentage usage of post-consumer recycled plastic (from 0% to 100%).

In another aspect of the invention, recyclable food grade plastic products are manufactured, at least in part, from bioplastic. In one form, the recyclable plastic products contain least 1% bioplastic, more preferably, at least 10% bioplastic, and even more preferably, at least 50% bioplastic. In any event, the current invention includes varying percentage usage of bioplastic (from 0% to 100%).

In another aspect of the invention, recyclable food grade plastic products are provided with printed text, graphics, or images that may be easily removed such that the plastic product may be recycled into FDA-approved food grade plastic that is capable of being reused to manufacture new recyclable food grade products.

In another aspect of the invention, a process is provided for recycling post-consumer, recyclable thermoformed food grade plastic products to manufacture new recyclable food grade plastic products. In one form, the method includes processing post-consumer, recyclable thermoformed food grade plastic products to provide clean washed thermoform flake, and then further processing the clean washed thermoform flake by, for example but not limited to, decontaminating, crystallizing, and/or solid-stating the clean washed thermoform flake to provide decontaminated FDA-approved food grade plastic flake that may be contained in a controlled environment and then extruded to FDA-approved food grade plastic pellets or sheet.

In one form, the post-consumer recyclable food grade plastic products may have text, graphics, or images printed thereon. Thus, in accordance with still a further aspect of the invention, methods are provided for recycling recyclable food grade plastic products with printed text, graphics, or images that may be easily removed such that the plastic product may be recycled into FDA approved food grade plastic that is capable of being reused to manufacture new food grade plastic products.

In still a further aspect of the invention, recyclable food grade plastic products such as food and beverage containers and cups are provided that incorporate “wash away” labels that are easily removed during the recycling process. Accordingly, the plastic products may then be easily recycled into FDA approved food grade plastic that may be reused to manufacture new food grade containers and cups. This “circular” sustainability effort will advantageously allow for millions of pounds of post-consumer plastic waste to be diverted from landfills every year and reused.

Other aspects of the invention are described herein.

### BRIEF DESCRIPTION OF THE DRAWINGS

Various other objects, features and attendant advantages of the current invention described herein may be more fully appreciated when considered in conjunction with the accompanying drawings, in which like reference numerals designate the same or similar parts throughout the several views, and wherein:

FIG. 1 is a flow diagram showing a method for making recyclable food grade plastic products, that may be recycled into food grade plastic, that may be reused in new recyclable food grade plastic products;

FIG. 2 is a perspective view of a recyclable beverage cup in accordance with an aspect of the invention;

FIG. 3 is a cross-section view of a wash away label in accordance with another aspect of the invention;

FIG. 4 is a cross-section view of a wash away label in accordance with another aspect of the invention;

FIG. 5 is a cross-section view of a wash away label in accordance with another aspect of the invention;

FIG. 6 is a cross-section view of a wash away label in accordance with another aspect of the invention;

FIG. 7 is a cross-section view of a wash away label in accordance with another aspect of the invention; and

FIG. 8 is a cross-section view of a wash away label in accordance with another aspect of the invention.

### DETAILED DESCRIPTION OF THE PREFERRED EMBODIMENTS

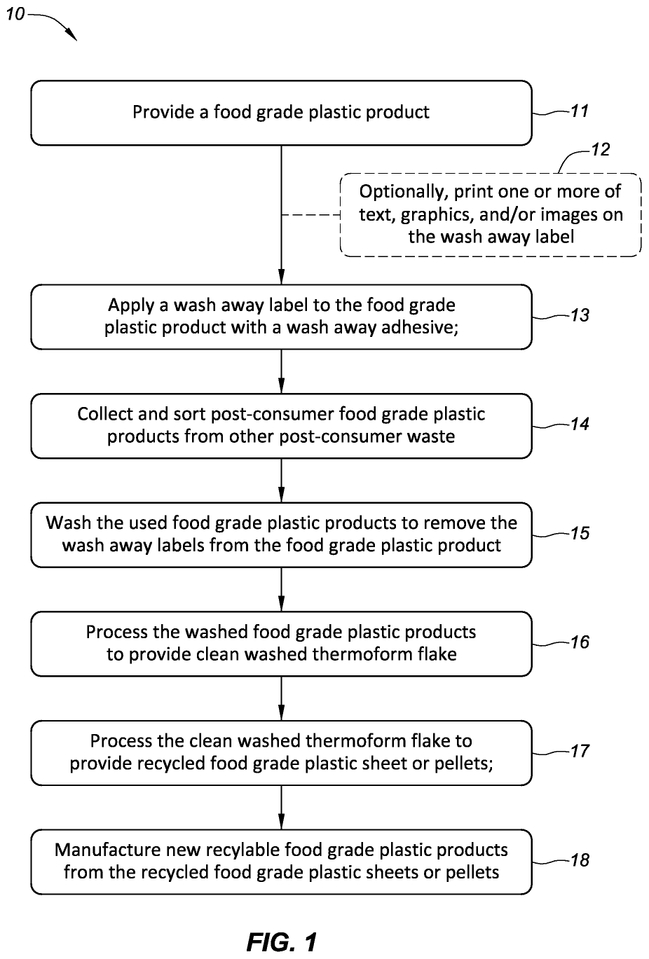

The current invention is now shown and described with reference to the figures. FIG. 1 describes a method 10 for making recyclable food grade plastic products (for example, thermoformed food and beverage containers and cups) that may be recycled into food grade plastic, that may be reused to manufacture new recyclable food grade plastic products. As shown, recyclable food grade plastic products may include wash away labels that may be easily removed thereby allowing the plastic products to be easily recycled into FDA-approved, food grade (i.e., food safe) plastic, that can be reused for new recyclable food grade plastic products. The methods described herein may preferably be used to advantageously achieve at or near 100% recycling of the recyclable food grade plastic products described herein. However, achieving other percentages of recyclability is within the scope of the invention.

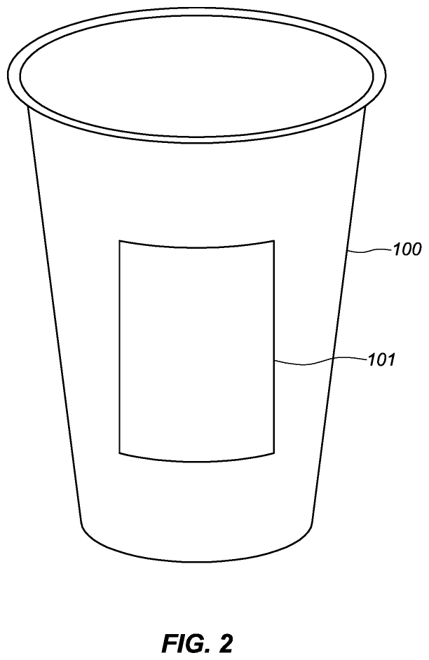

In one form, as illustrated in FIG. 1 and FIG. 2, a recyclable food grade plastic product 100 is provided in step 11. The food grade plastic product 100 may include any desired size and configured container or cup suitable for coming in contact with food and/or beverage. In one preferred form, the food grade plastic product 100 is a beverage cup.

The recyclable food grade plastic product 100 may be manufactured of any suitable food safe plastic, including for example, but not limited to, Polyethylene Terephthalate (PET) Thermoplastic, Polypropylene (PP) Thermoplastic, and/or High Density Polyethylene (HDPE). In one form, the recyclable food grade plastic product 100 may be manufactured from at least 1% recycled, post-consumer plastic, more preferably, at least 10% recycled, post-consumer plastic, and even more preferably, at least 50% recycled, post-consumer plastic. Most preferably, the recyclable food grade plastic product 100 is manufactured from 100% recycled, post-consumer plastic. In any event, varying percentages of recycled, post-consumer plastic is within the scope of the invention (from 0% to 100%). As used herein, post-consumer plastic refers generally to plastic that has been discarded by an end consumer.

In another form, the recyclable food grade plastic product 100 may be manufactured from a bioplastic resin. As used herein bioplastic refers to plastic resin derived at least in part from an earth plant-based compostable, biodegradable composition such as a composition as disclosed in U.S. Pat. Nos. 10,882,977, 11,149,131, 11,414,533, and/or 11,697,725, all of which are hereby incorporated by reference herein. In one form, the recyclable food grade plastic product 100 may be manufactured from at least 1% bioplastic, more preferably, at least 10% bioplastic, and even more preferably, at least 50% bioplastic. Most preferably, the recyclable food grade plastic product is manufactured from 100% bioplastic. In any event, varying percentages of bioplastic is within the scope of the invention (from 0% to 100%).

The recyclable plastic products 100 of the present invention may be manufactured using any suitable method, including for example, but not limited to, thermoforming and injection molding. In one preferred form, the recyclable plastic products 100 are thermoformed plastic products, including but not limited to, thermoformed food containers and beverage cups. In one preferred form, as illustrated in FIG. 1, post-consumer, recyclable food grade plastic products are processed to provide clean washed thermoform flake, and then the clean washed thermoform flake is further processed by, for example but not limited to, decontaminating, crystallizing, and/or solid-stating to provide decontaminated FDA-approved food grade plastic flake that may be contained in a controlled environment and then extruded to provide FDA-approved food grade plastic pellets or sheet.

As illustrated in FIG. 1, steps 12, 13, and 14 and FIG. 2, in accordance with another aspect of the invention, the recyclable food grade plastic products 100 may include a label 101 with text and/or images printed thereon. In one preferred form, the recyclable food grade plastic products 100 include a wash away, or wash-off or otherwise removable, label 101 that is easily removed during the cleaning and recycling process to permit recycling of the plastic products.

At this point in the process 10 of FIG. 1, a food grade, plastic product having a wash away label according to an embodiment of the current invention has been formed. More detail on the wash away label and the manner of its application is now provided.

The wash away label 101 may be applied 13 to the recyclable food grade plastic product 100 by any suitable means. In one form, the label may be shrink-wrapped about the entire body of the product or about a portion of the body of the product like a sleeve. In another form, the label may be affixed to the product with a suitable adhesive.

The wash away labels may include any suitable structure and composition. In one form, the wash away label has a multi-layer design including, for example, an outer polypropylene film, a wash away adhesive, and a PET inner liner.

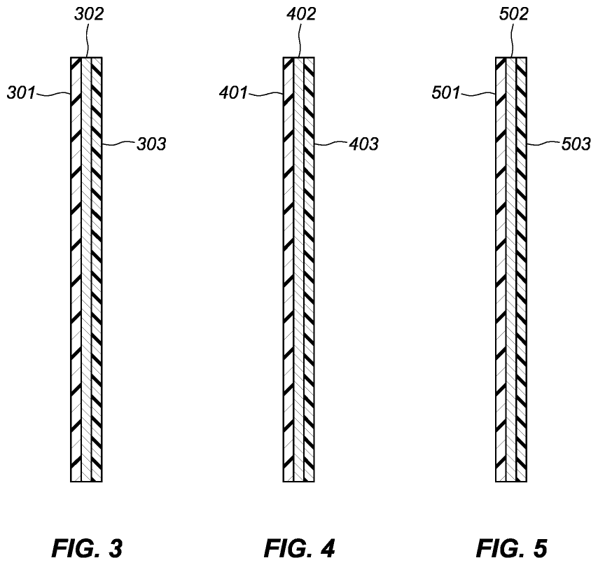

In another form, as illustrated in FIG. 3, the wash away label 101 may include a Biaxially Oriented Polypropylene (BOPP) outer film 303, a wash away adhesive layer 302, and a polyester inner liner 301. The BOPP outer film 303 may be clear, white, or other color or colors. Ink may be printed on either side of the BOPP outer film 303, that is, on the outside surface, or on the inside surface that faces the wash away adhesive layer 302. The adhesive layer may include, for example, but is not limited to, an emulsion acrylic that washes away as described below for recycling. The polyester inner liner 301 may preferably include, for example, an oriented Polyethylene Terephthalate (OPET) liner. The inner liner 301 may include other materials, for example, non-oriented PET, recycled PET, or oriented polystyrene (OPS), and the like.

In yet another form, as illustrated in FIG. 4, the wash away label 101 may include an Oriented Polystyrene (OPS) outer film 403, a wash away adhesive layer 401, and a polyester inner liner 401. The OPS outer film 403 may be clear, white, or another color or colors. Ink may be printed on either side of the OPS outer film 403, that is, on the outside surface, or on the inside surface that faces the wash away adhesive layer 402. The adhesive layer 402 may include, for example, but is not limited to, an emulsion acrylic that washes away as described below for recycling. The polyester inner liner 401 may preferably include, for example, an oriented Polyethylene Terephthalate (OPET) liner. The inner liner 401 may include other materials, for example, non-oriented PET, recycled PET, or oriented polystyrene (OPS), and the like.

In still another form, as illustrated in FIG. 5, the wash away label 101 may include a Biaxially Oriented PET (BOPET) or a non-oriented polyester outer film 503, a wash away adhesive layer 502, and a polyester inner liner 501. The BOPET or non-oriented polyester outer film 503 may be clear, white, or another color or colors. Ink may be printed on either side of the outer film 503, that is, on the outside surface, or on the inside surface that faces the wash away adhesive layer 502. The adhesive layer 502 may include, for example, but is not limited to, an emulsion acrylic that washes away as described below for recycling. The polyester inner liner 501 may preferably include, for example, an oriented Polyethylene Terephthalate (OPET) liner. The inner liner may 501 include other materials, for example, non-oriented PET, recycled PET, or oriented polystyrene (OPS), and the like.

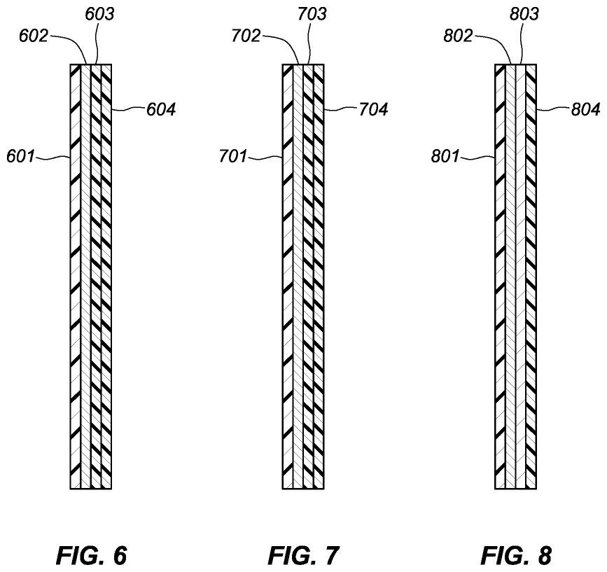

In yet another form, as illustrated in FIG. 6, the wash away label 101 may include first and second layers of a Biaxially Oriented Polypropylene (BOPP) outer film 603, 604, a wash away adhesive layer 602, and a polyester inner liner 601. The first and second layers of the BOPP outer film 603, 604 may be clear, white, or another color or colors. Ink may be printed on one or both of the first and second layers of BOPP 603, 604 such that it is trapped, or otherwise contained, therebetween. For example, ink may be printed on the inside surface of the first layer 604 (i.e., reverse printed) of BOPP, and/or it may be printed on the outside surface of the second layer of BOPP 603. The adhesive layer 602 may include, for example, but is not limited to, an emulsion acrylic that washes away as described below for recycling. The polyester inner liner 601 may preferably include, for example, an oriented Polyethylene Terephthalate (OPET) liner. The inner liner 601 may include other materials, for example, non-oriented PET, recycled PET, or oriented polystyrene (OPS), and the like.

In still a further form, as illustrated in FIG. 7, the wash away label 101 may include first and second layers of a biaxially oriented polystyrene (OPS) outer film 703, 704, a wash away adhesive layer 702, and a polyester inner liner 701. The first and second layers of the OPS outer film 703, 704 may be clear, white, or another color or colors. Ink may be printed on one or both of the first and second layers of OPS such that is trapped, or otherwise contained, therebetween. For example, ink may be printed on the inside surface of the first layer 704 (i.e., reverse printed) of OPS, and/or it may be printed on the outside surface of the second layer 703 of OPS. The adhesive layer 702 may include, for example, but is not limited to, an emulsion acrylic that washes away as described below for recycling. The polyester inner liner 701 may preferably include, for example, an oriented Polyethylene Terephthalate (OPET) liner. The inner liner 701 may include other materials, for example, non-oriented PET, recycled PET, or oriented polystyrene (OPS), and the like.

In still a further form, as illustrated in FIG. 8, the wash away label 101 may include an outer film comprising a first layer of a biaxially oriented polyester (BOPET) 804, and a second layer of BOPET or a non-oriented polyester 803, a wash away adhesive layer 802, and a polyester inner liner 801. The first and second layers outer film 803, 804 may be clear, white, or another color or colors. Ink may be printed on one or both of the first and second layers of outer film such that is trapped, or otherwise contained, therebetween. For example, ink may be printed on the inside surface of the first layer 804 (i.e., reverse printed) of BOPET, and/or it may be printed on the outside surface of the second layer 803. The adhesive layer 802 may include, for example, but is not limited to, an emulsion acrylic that washes away as described below for recycling. The polyester inner liner 801 may preferably include, for example, an oriented Polyethylene Terephthalate (OPET) liner. The inner liner 801 may include other materials, for example, non-oriented PET, recycled PET, or oriented polystyrene (OPS), and the like.

In one form, the outer film of the wash away label 101 may be suitable for surface printing or reverse printing, for example but not limited to, by UV inkjet, UV letterpress, and Flexographic UV, solvent, and water-based inks. As described above, the wash away label 101 may be surface printed or reverse printed. It may also be trapped, or otherwise contained, with the ink sandwiched between the outer film and the wash away adhesive layer, or between the first and second layers of the outer film.

The wash away labels 101 may also include additional label materials and layers including for example, transparent polyethylene film (PE film), transparent polyethylene film (PE film) manufactured from recycled granulate, transparent polypropylene film (PP film), white polypropylene film (PP film), and/or wet-strength and alkali-resistant paper, and the like. Other types of labels and label materials are within the scope of the invention.

In one preferred form, the wash away labels 101 may be clear and transparent. They are preferably designed to give the appearance that any text, graphics, or images printed thereon are printed directly on the plastic products. The margins of the label preferably may blend seamlessly into the container, so that the label is not visible unless inspected closely. In another form, the wash away label may be another color to either blend with or stand out from the color of the plastic product.

In another form, the wash away labels 101 may include customizable text, graphics and/or images. They may include, for example but are not limited to, brand indicators such as business, venue, or product names and/or logos, sports team names or logos, special event names, locations, and dates, and the like. They may also include, for example, promotional URLs or QR codes to prompt the consumer to action (for example: “enjoy 25% off if purchase is made by a certain date or time” or “enter to win” and the like).

In accordance with one aspect, the wash away off adhesive may include a wash-off acrylic emulsion. The wash away adhesive is advantageously designed to wash off under specific conditions, allowing recycling of the PET container or cup that it was applied to. In accordance with another aspect, the wash away labels 101 are advantageously resistant to temperature fluctuations, such as those associated with submersion in ice water or room temperature water, and UV light. They may be constructed to withstand humid and hot environments and normal washing conditions. These characteristics preferably render the wash-off labels 101 easier or more favorable to work with than traditional labels that use wet glue products.

In accordance with another aspect, as discussed in more detail with the washing step 15 of the process 10 of FIG. 1, the wash away labels 101 are preferably readily removed as they may advantageously shrink and peel off on their own during the washing process, minimizing waste volume and maximizing the ability to reuse the plastic products.

In another aspect, the inner liner layer of the wash away label may be rolled away as the wash away label 101 is applied to the plastic product. In one form, the inner liner is manufactured from at least a portion of recycled, post-consumer plastic. In another form, the inner liner that is removed from the wash away label during application is itself recyclable.

The recycling of used, or post-consumer, food grade plastic products is not further described with reference to the process 10 of FIG. 1.

In accordance with another aspect, the post-consumer plastic products of the present invention may advantageously be collected 14 in predetermined receptacles. In one form, the receptacles may include, for example, openings shaped and configured to accept the particular plastic products, for example, cups. The collected post-consumer plastic products may then be cleaned and recycled in accordance with standard recycling processes. In one form, the post-consumer plastic products may be sorted, bailed, and washed 15 to remove the wash away labels and any surface contamination from the plastic. The wash away labels' ease of removal, including separating residue, impurities, and inks, facilitates the recycling process so that it is smooth and rapid.

In one form, the wash away labels may advantageously be removed 15 in a hot water bath at temperatures at or below industry standard, for example, at about 80-100° F. In another form, the wash away labels may be removed 15 by being exposed to a solution of about 1-10% caustic acid and warm water. During the washing process 15, the wash away label may advantageously peel off and roll up, thereby separating itself from the plastic product with little to no effort.

Either before or after washing the wash away labels off 15, the plastic products may be processed by shredding, grinding, and the like to provide flake. The flake may then be further processed 16, for example, by applying detergent and/or caustic acid, rinsing, drying, sifting the fines, and/or sorting the flake to provide clean washed thermoform flake (“CWTF”). The CWTF may then be further processed 17 by, for example, but not limited to, decontaminating, crystallizing, and/or solid-stating the clean washed thermoform flake to provide decontaminated FDA-approved food grade plastic flake. In one preferred form the CWTF is dried and crystallized under negative pressure to decontaminate and solid-state the CWFT and form decontaminated, FDA-approved food grade plastic flake. The decontaminated, FDA-approved food grade plastic flake may then be contained in a controlled environment (i.e., free from moisture and/or other contaminants), by for example, but not limited to, applying a nitrogen blanket to the decontaminated flake, and then may be extruded to provide FDA-approved food grade plastic pellets or sheet. The resulting FDA-approved food grade plastic pellets or sheet may then be advantageously used to manufacture new FDA-approved food grade plastic products 18.

In accordance with another aspect, the post-consumer plastic products of the present invention may be recycled using conventional methods, including for example but not limited to, the following. PET and polypropylene (PP) may be recycled by Mechanical Recycling Coupled with Plastic Flake Decontamination as described above. OPET and PET may also be recycled using Liquid State Polycondensation (LSP). PET, PP, and HDPE may be recycled using Pyrolysis.

Advantageously, the “food grade” plastic that is extruded into new recycled plastic sheet and/or pellets may then be used to manufacture new recyclable food grade plastic products. This “circular” sustainability effort will advantageously allow millions of pounds of post-consumer plastic waste to be diverted from landfill and the environment every year and reused in new recyclable food grade plastic products.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A method for manufacturing a recyclable food grade plastic product from recycled, post-consumer food grade plastic, the method:
providing a post-consumer recyclable food grade plastic product comprising a thermoformed or injection molded container having a previously applied wash away label affixed thereto;
washing the post-consumer food grade plastic product in a hot water bath at a temperature between about 80-100° F. to remove the previously applied wash away label;
processing the washed food grade plastic product to obtain clean washed thermoform flake;
decontaminating the clean washed thermoform flake to provide decontaminated food grade plastic flake;
extruding the decontaminated food grade plastic flake to form recycled food grade plastic sheet or pellets; and
manufacturing a recyclable food grade plastic product from the recycled food grade plastic sheet or pellets.

2. The method of claim 1, wherein the recyclable food grade plastic product consists of a beverage cup.

3. The method of claim 1, wherein the recyclable food grade plastic product comprises at least 10% recycled, post-consumer plastic and/or bioplastic.

4. The method of claim 1, wherein the recyclable food grade plastic product comprises at least 50% recycled, post-consumer plastic and/or bioplastic.

5. The method of claim 1, further comprising applying a wash away label to the recyclable food grade plastic product using an emulsion acrylic-based wash away adhesive.

6. The method of claim 1, further comprising crystallizing and solid-stating the clean washed thermoform flake under negative pressure to provide decontaminated food grade plastic flake.

7. The method of claim 1, wherein the wash away label comprises an outer film layer, a wash away adhesive layer, and a polyester inner liner layer, and wherein the outer film layer is selected from the group consisting of: a Biaxially Oriented Polypropylene (BOPP) outer film, an Oriented Polystyrene (OPS) outer film, a Biaxially Oriented PET (BOPET) or a non-oriented polyester outer film, first and second layers of a Biaxially Oriented Polypropylene (BOPP) outer film, first and second layers of a biaxially oriented polystyrene (OPS) outer film, and a first layer of a biaxially oriented polyester (BOPET) and a second layer of BOPET or a non-oriented polyester.

8. The method of claim 1, wherein the wash away label is resistant to temperature fluctuations, humidity, and UV light.

9. The method of claim 1, wherein the wash away label is transparent and blends seamlessly with the food grade plastic product.

10. The method of claim 1, wherein the wash away label includes customizable text, graphics and/or images printed thereon.

11. A recyclable food grade plastic product, comprising:
a thermoformed or injection molded plastic container; and
a wash away label affixed thereto.

12. The recyclable food grade plastic product of claim 11, wherein the thermoformed or injection molded plastic container comprises a beverage cup.

13. The recyclable food grade plastic product of claim 11 comprising at least 10% recycled, post-consumer plastic and/or bioplastic.

14. The recyclable food grade plastic product of claim 11 comprising at least 50% recycled, post-consumer plastic and/or bioplastic.

15. The recyclable food grade plastic product of claim 11 comprising at least 99% recycled, post-consumer plastic and/or bioplastic.

16. The recyclable food grade plastic product of claim 11, wherein the wash away label is affixed using an emulsion acrylic-based wash away adhesive.

17. The recyclable food grade plastic product of claim 11, wherein the wash away label comprises an outer film layer, a wash away adhesive layer, and a polyester inner liner layer, and wherein the outer film layer is selected from the group consisting of: a Biaxially Oriented Polypropylene (BOPP) outer film, an Oriented Polystyrene (OPS) outer film, a Biaxially Oriented PET (BOPET) or a non-oriented polyester outer film, first and second layers of a Biaxially Oriented Polypropylene (BOPP) outer film, first and second layers of a biaxially oriented polystyrene (OPS) outer film, and a first layer of a biaxially oriented polyester (BOPET) and a second layer of BOPET or a non-oriented polyester.

18. The recyclable food grade plastic product of claim 11, wherein the wash away label is resistant to temperature fluctuations, humidity, and UV light.

19. The recyclable food grade plastic product of claim 11, wherein the wash away label is transparent and blends seamlessly with the food grade plastic product.

20. The recyclable food grade plastic product of claim 11, wherein the wash away label includes customizable text, graphics and/or images printed thereon.

21. The recyclable food grade plastic product of claim 11 that, after its use by a consumer, is recyclable into a new recyclable food grade plastic product.
